(19) United States
(12) Patent Application Publication
(10) Pub. No.: US 2014/0245746 A1
(43) Pub. Date: Sep. 4, 2014

(54) COMBUSTION ARRANGEMENT AND METHOD OF REDUCING PRESSURE FLUCTUATIONS OF A COMBUSTION ARRANGEMENT

(71) Applicant: GENERAL ELECTRIC COMPANY, Schenectady, NY (US)

(72) Inventors: Shiva Kumar Srinivasan, Greer, SC (US); James Scott Flanagan, Simpsonville, SC (US); Jeffrey Scott LeBegue, Simpsonville, SC (US); Kevin Weston McMahan, Greenville, SC (US)

(73) Assignee: GENERAL ELECTRIC COMPANY, Schenectady, NY (US)

(21) Appl. No.: 13/784,052

(22) Filed: Mar. 4, 2013

(51) Int. Cl. F23R 3/42; F02C 7/18

(52) U.S. Cl. CPC F23R 3/42; F02C 7/18
USPC 60/779; 60/725; 60/754

(57) ABSTRACT

A combustion arrangement includes a combustion section. Also included is an air discharge section downstream of the combustion section. Further included is a transition region disposed between the combustion section and the air discharge section. Yet further included is a transition piece defining the combustion section and the transition region, wherein the transition piece is configured to carry a combusted gas flow from the combustion section to the air discharge section. Also included is a damping device operatively coupled to the transition piece proximate the air discharge section.

### GOVERNMENT LICENSE RIGHTS

This application was made with U.S. Government support under Agreement No. DE-FC26-05NT42643 awarded by the Department of Energy. The U.S. Government may have certain rights in this invention.

### BACKGROUND OF THE INVENTION

The subject matter disclosed herein relates to gas turbine engines, and more particularly to a combustion arrangement, as well as a method of reducing pressure fluctuations of the combustion arrangement.

A combustor section of a gas turbine system typically includes a combustor chamber disposed relatively adjacent a transition region that routes hot gas from the combustor chamber to a turbine section. Traditionally, the combustor chamber is defined by a combustor liner that is surrounded by a flow sleeve, with the transition region defined by a transition liner that is surrounded by an impingement sleeve. More recently, combustor sections have included the combustor chamber and the transition region within a single liner. An aft end of the combustor section may experience large pressure fluctuations. Such pressure fluctuations may reduce the life of the liner, as well as buckets within the turbine section, due to a continuous imposition of high overall dynamics amplitudes for pressure tones exhibited at the aft end of the combustor section.

### BRIEF DESCRIPTION OF THE INVENTION

According to one aspect of the invention, a combustion arrangement includes a combustion section. Also included is an air discharge section downstream of the combustion section. Further included is a transition region disposed between the combustion section and the air discharge section. Yet further included is a transition piece defining the combustion section and the transition region, wherein the transition piece is configured to carry a combusted gas flow from the combustion section to the air discharge section. Also included is a damping device operatively coupled to the transition piece proximate the air discharge section.

According to another aspect of the invention, a damped exit of a transition piece includes an air discharge section located at a downstream end of a liner of the transition piece. Also included is a resonator operatively coupled to the liner proximate the air discharge section, wherein the resonator is configured to damp pressure fluctuations within the transition piece.

According to yet another aspect of the invention, a method of reducing pressure fluctuations of a combustion arrangement is provided. The method includes flowing a combusted gas flow through a transition region of a transition piece from a combustion section to an air discharge section. Also included is damping pressure fluctuations within the transition piece with a damping device operatively coupled to the transition piece proximate the air discharge section.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a turbine system;

FIG. 2 is a partial cross-sectional, schematic illustration of a combustion arrangement of the turbine system;

FIG. 3 is a rear elevational view of a damping device of the combustion arrangement; and

FIG. 4 is a flow diagram illustrating a method of reducing pressure fluctuations of a combustion arrangement.

The detailed description explains embodiments of the invention, together with advantages and features, by way of example with reference to the drawings.

### DETAILED DESCRIPTION OF THE INVENTION

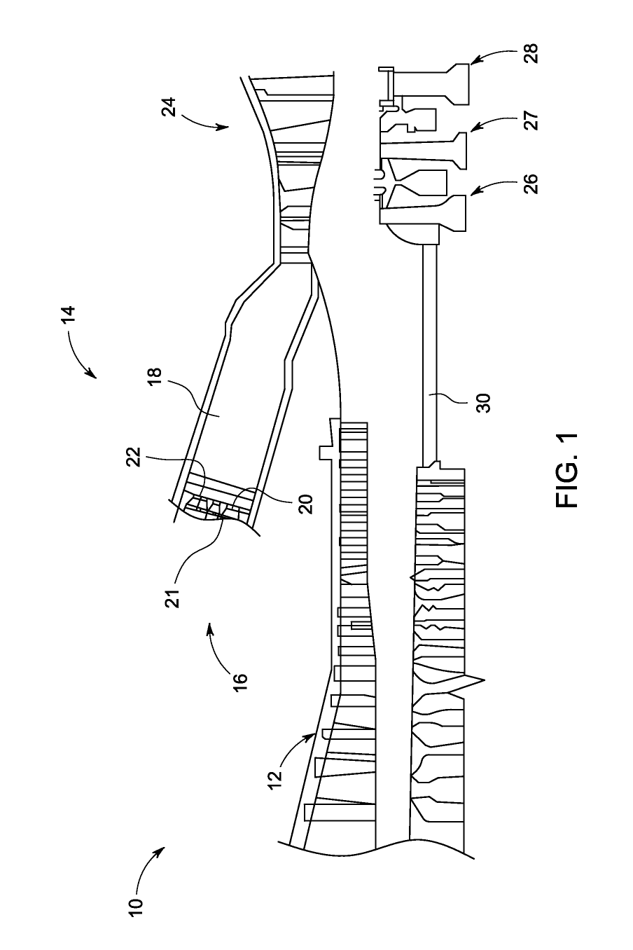

Referring to FIG. 1, a gas turbine engine 10 constructed in accordance with an exemplary embodiment of the present invention is schematically illustrated. The gas turbine engine 10 includes a compressor 12 and a plurality of combustor assemblies arranged in a can annular array, one of which is indicated at 14. As shown, the combustion arrangement 14 includes an endcover assembly 16 that seals, and at least partially defines, a combustion section 18. A plurality of nozzles 20-22 are supported by the endcover assembly 16 and extend into the combustion section 18. The nozzles 20-22 receive fuel through a common fuel inlet (not shown) and compressed air from the compressor 12. The fuel and compressed air are passed into the combustion section 18 and ignited to form a high temperature, high pressure combustion product or air stream that is used to drive a turbine 24. The turbine 24 includes a plurality of stages 26-28 that are operationally connected to the compressor 12 through a compressor/turbine shaft 30 (also referred to as a rotor).

In operation, air flows into the compressor 12 and is compressed into a high pressure gas. The high pressure gas is supplied to the combustion arrangement 14 and mixed with fuel, for example natural gas, fuel oil, process gas and/or synthetic gas (syngas), in the combustion section 18. The fuel/air or combustible mixture ignites to form a high pressure, high temperature combustion gas stream. In any event, the combustion arrangement 14 channels the combustion gas stream to the turbine 24 which converts thermal energy to mechanical, rotational energy.

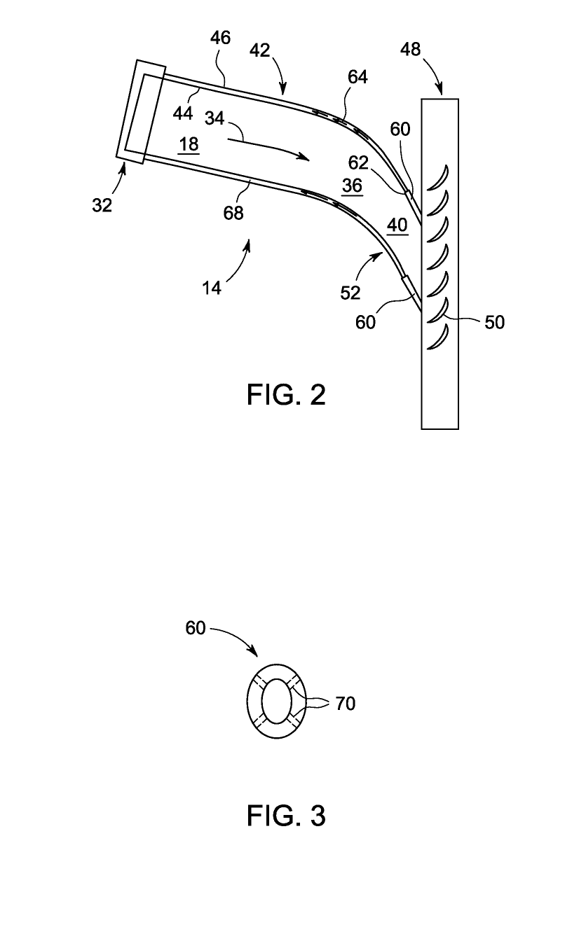

Referring now to FIGS. 2 and 3, the combustion arrangement 14 is schematically illustrated in greater detail. As noted above, fuel and air are mixed in the combustion section 18 proximate a head end 32 of the combustion arrangement 14, thereby resulting in a combusted gas flow 34. The combusted gas flow 34 is routed through a transition region 36 of the combustion arrangement 14 to an air discharge section 40 located at a downstream end of the combustion arrangement 14.

In one embodiment, a transition piece 42 is included and comprises a liner 44 that transitions as a single component directly from the head end 32, which may be of a substantially circular geometry, to the air discharge section 40, which may be of an oval cross-sectional geometric configuration that corresponds to an annular exit for the combusted gas flow 34 to a segment of the turbine 24. The liner 44 may be formed from two halves or several components welded or joined together for ease of assembly or manufacture. A sleeve 46 at least partially surrounds and is disposed radially outwardly of the liner 44. The sleeve 46 also transitions directly from the head end 32 to the air discharge section 40 as a single component. Similar to the liner 44, the sleeve 46 may be formed from two halves and welded or joined together for ease of assembly or manufacture. It is to be understood that reference to a “single” component, as employed above with respect to the liner 44 and the sleeve 46, may refer to multiple pieces joined together to form a single overall structure, where the joining is by any suitable process to join elements.

The air discharge section 40 may be shaped in various configurations to achieve desirable exit conditions of the combusted gas flow 34 at the point of expulsion to the turbine 24, and more specifically for delivery of the combusted gas flow 34 to a first stage 48 of the turbine 24. The first stage 48 typically includes a plurality of airfoils 50, such as a row of circumferentially spaced nozzles or buckets. In one embodiment, the transition piece 42 is shaped in what is referred to as a choked flow region 52 proximate the air discharge section 40. The choked flow region 52 refers to a region that imposes a restriction on the combusted gas flow 34 by decreasing the cross-sectional area through which the combusted gas flow 34 passes through. Due to the restriction, as well as a lower pressure environment of the turbine 24 disposed downstream of the choked flow region 52, the fluid velocity of the combusted gas flow 34 increases. The choked flow region 52 may be employed to mimic a first stage nozzle of the turbine 24, such that inclusion of the first stage nozzle is optional.

One effect of routing the combusted gas flow 34 through the choked flow region 52 is a large magnitude of pressure fluctuation proximate the air discharge section 40. To dampen the pressure fluctuations experienced, a damping device 60 is operatively coupled to the transition piece 42 proximate the air discharge section 40. In one embodiment, the damping device 60 is coupled to an outer surface 62 of the liner 44, and between the liner 44 and the sleeve 46 for embodiments including the sleeve 46. Alternatively, the damping device 60 may be coupled to an outer portion of the sleeve 46. Irrespective of the precise location of coupling of the damping device 60 to the transition piece 42, the damping device 60 may partially surround or fully surround the transition piece 42 along an axial segment of the transition piece 42.

In an exemplary embodiment, the damping device 60 comprises a resonator, which may be of an electromagnetic or mechanical type. The resonator exhibits resonance or resonant behavior, that is, it naturally oscillates at some frequencies, called its resonant frequencies, with greater amplitude than at others. The resonant frequencies may be configured to dampen the overall pressure fluctuations exhibited proximate the air discharge section 40 by reducing the amplitude of pressure anti-nodes.

The damping device 60 may also include at least one, but typically a plurality of cooling holes 70 for routing of a cooling flow 64 to the outer surface 62 of the liner 44 (FIG. 3). The cooling flow 64 is typically provided as compressed air from the compressor 12 and is routed in an annulus 68 between the liner 44 and the sleeve 46.

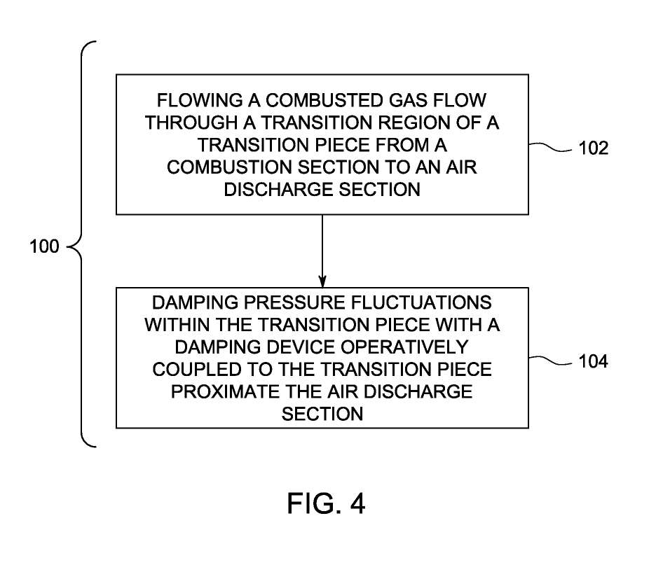

As illustrated in the flow diagram of FIG. 4, and with reference to FIGS. 1-3, a method of reducing pressure fluctuations of a combustion arrangement 100 is also provided. The gas turbine engine 10 and more particularly the combustion arrangement 14, as well as associated components have been previously described and specific structural components need not be described in further detail. The method of reducing pressure fluctuations of a combustion arrangement 100 includes flowing a combusted gas flow through a transition region of a transition piece from a combustion section to an air discharge section 102. Pressure fluctuations are damped within the transition piece with a damping device operatively coupled to the transition piece proximate the air discharge section 104.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A combustion arrangement comprising:
a combustion section;
an air discharge section downstream of the combustion section;
a transition region disposed between the combustion section and the air discharge section;
a transition piece defining the combustion section and the transition region, wherein the transition piece is configured to carry a combusted gas flow from the combustion section to the air discharge section; and
a damping device operatively coupled to the transition piece proximate the air discharge section.

2. The combustion arrangement of claim 1, wherein the damping device comprises a resonator.

3. The combustion arrangement of claim 2, wherein the resonator comprises an electromagnetic resonator.

4. The combustion arrangement of claim 2, wherein the resonator comprises a mechanical resonator.

5. The combustion arrangement of claim 1, wherein the transition piece comprises a liner having an outer surface, wherein the damping device is operably coupled to the outer surface.

6. The combustion arrangement of claim 5, wherein the damping device fully surrounds the liner along the outer surface.

7. The combustion arrangement of claim 1, wherein the transition piece further comprises a sleeve disposed outwardly of an outer surface of a liner of the transition piece.

8. The combustion arrangement of claim 7, wherein the damping device is configured to provide a cooling flow to the liner through a plurality of holes disposed in the sleeve.

9. The combustion arrangement of claim 7, wherein the damping device is disposed between the sleeve and the liner.

10. The combustion arrangement of claim 7, wherein the damping device is disposed outwardly of the sleeve.

11. The combustion arrangement of claim 1, wherein the air discharge section comprises a choked flow region.

12. A damped exit of a transition piece comprising:
an air discharge section located at a downstream end of a liner of the transition piece; and
a resonator operatively coupled to the liner proximate the air discharge section, wherein the resonator is configured to damp pressure fluctuations within the transition piece.

13. The damped exit of the transition piece of claim 12, wherein the resonator comprises an electromagnetic resonator.

14. The damped exit of the transition piece of claim 12, wherein the resonator comprises a mechanical resonator.

15. The damped exit of the transition piece of claim 12, wherein the resonator fully surrounds an outer surface of the liner.

16. The damped exit of the transition piece of claim 12, wherein the resonator is disposed between a sleeve and the liner, wherein the sleeve is outwardly disposed of the liner.

17. The damped exit of the transition piece of claim 12, wherein the resonator is disposed outwardly of a sleeve surrounding the liner.

18. A method of reducing pressure fluctuations of a combustion arrangement comprising:
flowing a combusted gas flow through a transition region of a transition piece from a combustion section to an air discharge section; and
damping pressure fluctuations within the transition piece with a damping device operatively coupled to the transition piece proximate the air discharge section.

19. The method of claim 18, further comprising reducing pressure anti-nodes proximate the air discharge section with the damping device.

20. The method of claim 18, wherein the damping device comprises a resonator.
